(19) United States
(12) Patent Application Publication
(10) Pub. No.: US 2013/0211672 A1
(43) Pub. Date: Aug. 15, 2013

(54) TIME-OF-FLIGHT CAMERA FOR A MOTOR VEHICLE, MOTOR VEHICLE AND METHOD FOR OPERATING A TIME-OF-FLIGHT CAMERA

(71) Applicant: Audi AG, (US)

(72) Inventor: Martin ROEHDER, Ingolstadt (DE)

(73) Assignee: Audi AG, Ingolstadt (DE)

(21) Appl. No.: 13/763,018

(22) Filed: Feb. 8, 2013

(30) Foreign Application Priority Data
Feb. 14, 2012 (DE) 10 2012 002 922.5

(51) Int. Cl. G06F 17/00

(52) U.S. Cl. CPC G06F 17/00
USPC 701/36

(57) ABSTRACT

A Time-Of-Flight camera for a motor vehicle includes an illumination unit with a light source and an optic for illuminating an illumination area, a camera unit for measuring measuring data and a control unit, wherein light emitted by the light source and reflectively detected by the camera unit is analyzable for determination of a distance information, wherein at least one piezoelectric actuating device is operably connected to the optic for adjusting the illumination area, and the control unit is configured for controlling the actuation device in dependence on at least one operating parameter which describes the driving situation of the motor vehicle.

### CROSS-REFERENCES TO RELATED APPLICATIONS

This application claims the priority of German Patent Application, Serial No. 10 2012 002 922.5, filed Feb. 14, 2012, pursuant to 35 U.S.C. 119(a)-(d), the disclosure of which is incorporated herein by reference.

### BACKGROUND OF THE INVENTION

The invention relates to a Time-Of-Flight camera for a motor vehicle, a motor vehicle with such a Time-Of-Flight camera and a method for operating such a Time-Of-Flight camera.

The following discussion of related art is provided to assist the reader in understanding the advantages of the invention, and is not to be construed as an admission that this related art is prior art to this invention.

Time-Of-Flight cameras (often also referred to in short as TOF cameras) are largely known in the state of the art and are increasingly used in motor vehicles. The advantage of a Time-Of-Flight camera is that beside image information, it also provides items of three-dimensional information. This means, each pixel can be assigned an item of distance information. For measuring the distance, a TOF method is used from which the name of this measuring device is derived.

The scene to be detected is illuminated by means of a light pulse, wherein the camera unit measures for each image point the time required for the light to travel to and return from the recorded object. This time can also be obtained by a correlative analysis when analyzing phase differences between the emitted light and the received light and the like. From this time of flight, a distance to the object can then be concluded. In order to realize this, a Time-Of-Flight camera, beside the camera unit, also has an illumination unit with which the scene is illuminated. Such an illumination unit has a first light source downstream of which an optic is connected, so that the illumination unit can light up the desired area for a short period of time. The reflected light is then collected via a lens of the camera, and the time of flight is recorded for each pixel.

In motor vehicles, Time-Of-Flight cameras are often used in order to provide measurement data for different vehicle systems. Exemplary fields of use are the active pedestrian protection, the collision monitoring and the like, in short, mostly the detection of the environment.

The detection range of a Time-Of-Flight camera is limited by the opening angle of the active illumination and the light intensity of the illumination, i.e., the illuminated area. The illuminated area described by the opening angle and range is initially determined by a specific configuration of the vehicle. Compromises are made with regard to different driving situations. For improving the adjustment to different driving situations the Time-Of-Flight camera, i.e., concretely the camera unit and the illumination unit may be provided with a zoom optic to thereby configure the opening angle and the range adjustable, which is not a feasible option, however, due to the complexity and the costs of such a system.

It would therefore be desirable and advantageous to provide an improved method to better adapt the operation of the Time-Of-Flight camera to different driving situations or operating conditions of the motor vehicle.

### SUMMARY OF THE INVENTION

According to one aspect of the present invention, a Time-Of-Flight camera for a motor vehicle includes an illumination unit for illuminating an illumination area, wherein the illumination unit includes a light source and an optic, a camera unit constructed for detecting the light emitted by the light source as reflected light, and for analyzing the reflected light and the emitted light to obtain measuring data including a distance information; at least one piezoelectric actuating device operably connected to the optic for adjusting the illumination area, and a control unit for controlling the actuation device as a function of at least one operating parameter describing a driving situation of the motor vehicle.

According to the invention, it is thus proposed to provide adjustability only on the optic of the illumination unit, because it has been recognized that a change/adjustment of the illumination area is sufficient in order to adjust the effective detection range of the Time-Of-Flight camera to a driving situation, because reflection of the light of the light source only takes place in the illuminated area and thus three dimensional measuring data are recorded independent of the capability of the camera unit to record greater ranges if needed. Concretely, the camera unit can thus also have a detection range which includes all settable illumination areas. The absolute detection range of the camera unit, i.e., of the corresponding object and the image sensor, thus encompasses all actual detection ranges which are predetermined by the illumination area, in particular with regard to the possible detection angle. The camera unit can in particular be provided with a greater angular resolution compared to previous Time-Of-Flight cameras. However, only the illumination is adaptively adjusted to the situation.

Thus, adjustment of only the illumination area allows a cost effective adjustment of the effective detection range without excessively increasing the complexity of the system, in particular cost and effort. Since only the imaging properties of the optic have to be configured variable, the demands on the optic are relatively low in this regard so that inexpensive components for example plastic-lenses can be used. Compared to an adjustability of the absolute detection range which also affects the camera unit, the invention provides a much simpler and cost effective solution.

According to another advantageous feature of the present invention, the optic can have at least one lens, in particular made of plastic, whose position is adjustable by the actuation device, in particular in a direction in which light is emitted by the light source. The optic can thus have at least one lens which is shiftable by the actuation device so that the illumination area changes appropriately. Thus, for example the distance between the emitting light source, in particular between a light emitting diode and a focusing lens, can be varied. It is also conceivable that the optic has a focusing lens and a defocusing lens which is arranged downstream of the focusing lens and is shiftable by the actuation unit. In this case, the light rays of the light source are first parallelized and then defocused by the defocusing lens whose position can be changed, so that a desired illumination area results. Generally, it is of course also conceivable to provide further lenses. It is also possible to include additional lenses similar to a zoom lens.

It is also conceivable to use lenses which can be changed regarding their characteristic, however a positional change of the lens is preferred due to the simpler and more cost effective realization.

Preferably, the actuation device can be a piezoelectric actuation device. For example lenses can be shifted piezoelectrically. For this, known materials are used, which undergo a deformation, in particular a size change when applying an electric voltage, thus enabling extremely fine adjustments.

Further, the speed of the motor vehicle and/or the speed of the motor vehicle relative to at least one detected object in the environment can be used as the at least one operating parameter. For example, it is also conceivable to control the opening angle and/or the range of the illumination in dependence on the measured speed or relative speed of the vehicle. In particular when the Time-Of-Flight camera is oriented forward in the motor vehicle, a high speed can be assigned to a higher range and/or a smaller opening angle of the illumination area than a lower speed. In this way, the effectiveness of forward looking safety systems can be increased because the greater angular ranges become irrelevant at higher speeds. In a forward looking safety function, a greater opening angle with lower range may thus for example be realized in the low speed range, and in the high speed range a narrow opening angle with higher range may be realized. An example is in particular a system for pedestrian protection in which a broad opening angle at low speeds relative to the pedestrian as environmental object can be useful, because the motor vehicle moves a shorter distance per time unit and thus, pedestrians who are present near the motor vehicle can also still be relevant as collision objects. At high speed however, pedestrians who are further away are more relevant.

According to another advantageous feature of the present invention, the Time-Of-Flight camera can be operated in at least two operating modes, and in each mode being assigned to a respective illumination area, or the illumination area can be continuously changed in dependence on the at least one operating parameter. Thus, two operating modes are conceivable which can for example depend on which vehicle system actually analyzes the measuring data of the Time-Of-Flight camera. If for example the goal in an actually delivered function is the detection of road signs, a wider and shorter range illumination area is useful. However, when merely other road users which drive in front are to be analyzed, a great range is desired, the opening angle however can remain small. Correspondingly, it can be switched between two or more modes of operation depending on the requesting vehicle system or requesting function, in order to provide greater flexibility. It is also conceivable however, to realize a continuous adjustment, for example by a characteristic diagram defined as a function of an operating parameter.

Overall, the present invention enables an adaption of the Time-Of-Flight camera to different driving situations since it was recognized that there are traffic situations which on one hand require a high range of the sensor system, and on the other hand situations which for example require a great opening angle. The previous configuration of the fixed effective detection range, in particular the fixed illumination area, was a compromise sacrificing potential which may now be used within the framework of the invention in particular for forward looking safety systems.

Beside the Time-Of-Flight camera the present invention also relates to a motor vehicle, including a Time-Of-Flight camera according to the invention. The Time-Of-Flight camera can for example be mounted in the front region of the motor vehicle so as to be oriented in driving direction in order to serve for detecting the environment. The Time-Of-Flight camera is actuated via at least one control device of the motor vehicle which can also provide the operating parameters which for example are provided by corresponding sensors and/or vehicle systems. In particular, the Time-Of-Flight camera can be assigned to one of multiple vehicle systems, in particular at least one forward looking safety system, which can then analyze the measuring data of the Time-Of-Flight camera. The communication of the Time-Of-Flight camera can for example be realized by a conventional bus system used in a motor vehicle, in particular a CAN-Bus.

According to another advantageous feature of the present invention, at least two vehicle systems can be provided that analyze measuring data of the Time-Of-Flight camera, wherein the illumination area is adjustable in dependence on the vehicle system which actually analyzes the measuring data. This is the already mentioned case with two operating modes which are specifically adapted to the analyzing vehicle systems or the concretely active functions, which analyze the measuring data of then Time-Of-Flight camera.

All embodiments with regard to the Time-Of-Flight camera can be analogously applied to the motor vehicle according to the invention so that the advantages which were already described there can be achieved.

According to another aspect of the present invention, a method for operating a Time-Of-Flight camera for a motor vehicle, includes the steps of illuminating an illumination area with light emitted by a light source of an illumination unit of the Time-Of-Flight camera, detecting the light emitted by the light source as reflected light with a camera unit of the Time-Of-Flight camera, analyzing the reflected light and the emitted light for determining an item of distance information, and adjusting the illumination area as a function of at least one operating parameter describing a driving situation of the motor vehicle, by controlling a piezoelectric actuation device with a control unit, said piezoelectric actuation device being operably connected to an optic of the illumination unit. The same advantages already mentioned with regard to the Time-Of-Flight camera according to the invention and the motor vehicle according to the invention also apply to the method according to the invention which for example can be implemented by the control unit itself.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic representation of a motor vehicle according to the invention;

FIG. 2 shows a schematic representation of a Time-Of-Flight camera according to the invention;

FIG. 3 shows a first illuminated area used at low speeds; and

FIG. 4 shows a second illuminated area used at high speeds.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

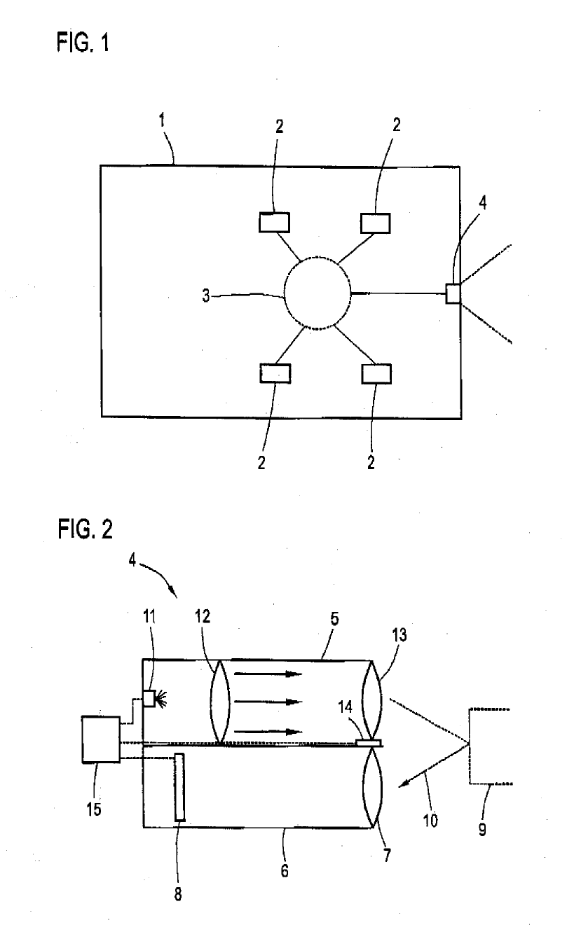

Turning now to the drawing, and in particular to FIG. 1, there is shown a schematic diagram of a motor vehicle 1 according to the invention. The latter has, as is generally known, a multitude of vehicle systems 2, several of which are outlined exemplary in FIG. 2. These vehicle systems include driver assist systems, control devices, sensors and the like. They communicate with one another via a Bus system 3, here a CAN-Bus. In particular, the motor vehicle 1 in the shown case includes also a Time-Of-Flight camera 4 according to the invention which in the present case is oriented in driving direction, and whose data are to be analyzed by forward looking safety systems of the vehicle systems 2.

The Time-Of-Flight camera according to the invention is shown in more detail in the schematic diagram of FIG. 2. As is generally known, it includes an illumination unit for illuminating a defined illumination area at an opening angle and a range in front of the motor vehicle and a camera unit 6, in which light, arrow 10, which has been reflected by an object 9, can be received by means of an image sensor 8 which is located downstream of an objective 7 and can in particular also be analyzed with regard to its run time. The illumination unit 5 includes a light source 11, which in this case is configured as a light emitting diode. Located downstream of the light source 11 is an optic which in the present case includes a focusing lens 12 and a defocusing lens 13. The arrangement of the lenses 12, 13 determines the illuminated area.

A piezoelectric actuating device 14 is assigned to the defocusing lens 13, via which the defocusing lens 13 is shiftable relative to the focusing lens 12 and the light source 11, so that the illumination area changes during shifting.

The different components of the Time-Of-Flight camera 4 and their operation are controlled by a control unit 15, which is also in particular configured for implementing the method according to the invention, this means it controls the control device 14 in dependence on at least one operating parameter that describes the driving situation of the motor vehicle 1, for adjusting the illumination area.

These operating parameters are provided by other vehicle systems 2 via the Bus system 3, wherein the Time-Of-Flight camera 4 can also be controlled via a dedicated control device.

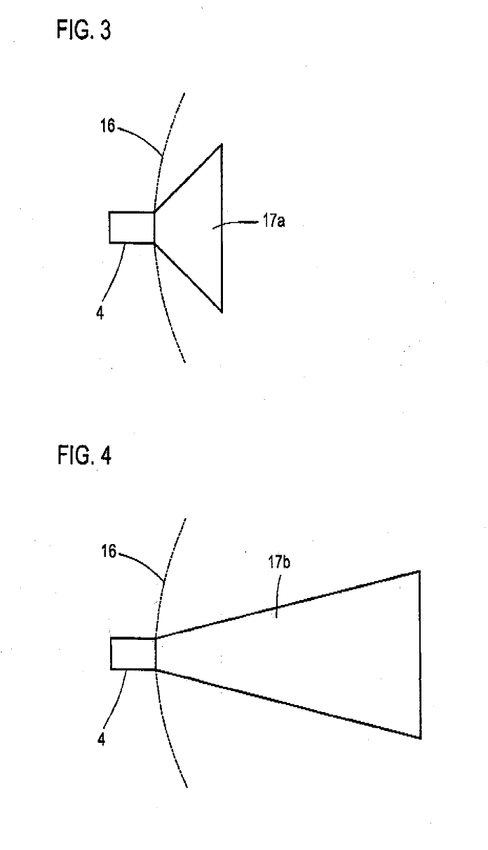

In the present exemplary embodiment, the measuring data are analyzed by a forward looking safety system, in which at low speeds a greater opening angle and a low range are suitable, while at high speeds a greater range at a narrower opening angle of the illumination area is required. Accordingly, the actuating unit 14 is controlled in dependence on the actual speed of the motor vehicle 1 for shifting the defocusing lens 13 and with this for changing the illumination area, in that for example an appropriate characteristic curve is present in the control unit 15 which links the driving speed with a setting of the actuation device 14. This is explained in more detail by way of FIGS. 3 and 4.

In FIG. 3 and FIG. 4 the absolute detection range 16 of the camera unit 6 is shown in more detail, i.e., the range from which due to the fixed defined optic of the objective 7 reflected light can be received in the first place. Here, an extremely wide opening angle is selected so that the detection range 16 includes the illumination areas of all possible settings of the actuation device 14.

FIG. 3 shows the situation in which the motor vehicle 1 drives relatively slow, at a speed of 30 km/h. This means that the illumination area 17a provided in this case has a relatively great opening angle but a small range. In this way, objects in the environment which are present on a side of the motor vehicle 1 can be relevant for the safety of the motor vehicle 1, while distant objects are less relevant due to the slow speed. As shown in FIG. 4, the situation is different at higher speeds, in this case, for example at a speed of the motor vehicle 1 of 120 km/h. As can be seen, the opening angle of the illumination area 17b in this case is significantly smaller, but the range is increased. This is adapted to the demands of a forward looking safety system at the different speeds.

Of course, further and/or other operating parameters can be taken into account when controlling the actuation device 14 and with this the illumination area 17. For example, an illumination area 17 can be selected depending on which vehicle system 2 or which function is to analyze the data of the Time-Of-Flight camera at a given moment. For recognizing road signs for example, a short-range illumination area 17 with wide opening angle is required, while when observing other road users driving in front, a great range at small opening angle is desired, comparable also to the differences of FIG. 3 to FIG. 4, illumination areas 17a and 17b. Then, two modes of operation of the Time-Of-Flight camera can for example be provided of which one is selected depending on the actually active function. However, the speed of the motor vehicle relative to objects in the environment can also be observed, for example in the case of a pedestrian, where the relative speed between a pedestrian and the motor vehicle 1 is a criteria for adjusting the illumination area. As can be seen, a multitude of possibilities are conceivable to adjust the illumination area to the actual driving situation.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A Time-Of-Flight camera for a motor vehicle, comprising:
an illumination unit for illuminating an illuminated area, said illumination unit including a light source and an optic;
a camera unit constructed for detecting the light emitted by the light source as reflected light, and for analyzing the reflected light and the emitted light to obtain measuring data including a distance information;
at least one actuating device operably connected to the optic for adjusting the illumination area; and
a control unit for controlling the actuation device as a function of at least one operating parameter describing a driving situation of the motor vehicle.

2. The Time-Of-Flight camera of claim 1, wherein the actuation device is constructed as piezoelectric actuation device.

3. The Time-Of-Flight camera of claim 1, wherein the camera unit has a detection range encompassing the illumination area.

4. The Time-Of-Flight camera of claim 1, wherein the optic includes at least one lens, wherein a position of the at least one lens is adjustable by the actuation device.

5. The Time-Of-Flight camera of claim 4, wherein the position of the lens is adjustable in a direction in which the light is emitted by the light source

6. The Time-Of-Flight camera of claim 4, wherein the at least one lens is made of plastic.

7. The Time-Of-Flight camera of claim 4, wherein the optic includes a focusing lens and a defocusing lens arranged downstream of the focusing lens, said defocusing lens being shiftable the actuation device.

8. The Time-Of-Flight camera of claim 1, wherein the at least one operating parameter includes at least one of a speed of the motor vehicle and a speed of the motor vehicle relative to at least one object detected in an environment of the motor vehicle.

9. The Time-Of-Flight camera of claim 8, wherein the control unit is constructed to control the actuating device so that a range of the illumination area is higher and/or an opening angle of the illumination area is smaller in response to a high speed of the motor vehicle than in response to a lower speed of the motor vehicle.

10. The Time-Of-Flight camera of claim 9, wherein the Time-Of-Flight camera is oriented in the motor vehicle in a driving direction of the motor vehicle.

11. The Time-Of-Flight camera of claim 1, constructed for operation in at least two operating modes, each said operating mode being assigned a respective one of said illumination area.

12. The Time-Of-Flight camera of claim 1, wherein the illumination area is continuously adjustable as a function of the at least one operating parameter.

13. The Time-Of-Flight camera of claim 1, wherein the light source includes at least one light emitting diode.

14. A motor vehicle, comprising a Time-Of-Flight camera, said Time-Of-Flight camera comprising an illumination unit for illuminating an illuminated area, said illumination unit including a light source and an optic; a camera unit for reflectively detecting light emitted by the light source and for analyzing the light to determine a distance information; at least one piezoelectric actuating device operably connected to the optic for adjusting the illumination area; and a control unit for controlling the actuation device in dependence on at least one operating parameter describing a driving situation of the motor vehicle.

15. The motor vehicle of claim 14, further comprising at least two vehicle systems for analyzing the measuring data of the Time-Of-Flight camera, wherein the illuminated area is adjustable as a function of which one of the at least two vehicle systems actually measures the measuring data.

16. A method for operating a Time-Of-Flight camera for a motor vehicle, comprising:
illuminating an illuminated area with light emitted by a light source of an illumination unit of the Time-Of-Flight camera;
detecting the light emitted by the light source as reflected light with a camera unit of the Time-Of-Flight camera;
analyzing the reflected light and the emitted light for determining an item of distance information; and
adjusting the illuminated area as a function of at least one operating parameter describing a driving situation of the motor vehicle, by controlling a piezoelectric actuation device with a control unit, said piezoelectric actuation device being operably connected to an optic of the illumination unit.
